(19) United States
(12) Patent Application Publication
(10) Pub. No.: US 2015/0254416 A1
(43) Pub. Date: Sep. 10, 2015

(54) METHOD AND SYSTEM FOR PROVIDING MEDICAL ADVICE

(71) Applicant: ClickMedix, Gaithersburg, MD (US)

(72) Inventor: Ting-Chih Shih, Rockville, MD (US)

(73) Assignee: CLICKMEDIX, Gaithersburg, MD (US)

(21) Appl. No.: 14/199,559

(22) Filed: Mar. 6, 2014

(51) Int. Cl. G06F 19/00

(52) U.S. Cl. CPC G06F 19/3425; G06F 19/322

(57) ABSTRACT

A method and system for providing medical services wherein a server establishes a wireless connection with a mobile device or computer of a user. The mobile device or computer has already been provided with an application for the entry of user information. The server receives encrypted user information from the mobile device or computer, decrypts the user information, and forwards the user information to experts selected on the basis of the user information. The server collects responses from the experts, and provides expert advice to the user of the mobile device or computer.

### BACKGROUND

1. Technical Field

The present invention relates to a method and system for facilitating the provision of expert advice, in particular medical expert advice, using a server in connection with at least one mobile device or computer.

2. Background Art

At present, an ill patient who wishes to seek a medical referral from her doctor, health care provider (includes nurses, pharmacists, health workers), friends, family, or caregiver is limited to the immediate social or professional network of the referrer. At most, this network is likely limited to a small number of different doctors or specialists, from whom the referrer likely chooses one to be the referred doctor. Even if the doctor lacks direct experience with the patient's precise condition, it is likely that they are familiar enough to provide adequate care or otherwise refer the patient to a third-degree specialist with the requisite experience.

This process can take weeks or longer, and the patient may visit multiple, different referred doctors, but still be unable to distinguish among the referred doctors other than on the basis of their education or stated expertise. The patient is not privy to information such as other experts' opinions of the specialists; the quality and general reception of the specialists' peer-reviewed medical journal articles, if any; or how often or how many times the specialists have had direct practical experience with the patient's specific condition.

Although recent uses of the Internet have changed the health care provider search process to some degree, the prospect of identifying the right expert remains difficult. Patients have access to a far higher number of doctors by searching online, but they are similarly unable to distinguish between the doctors other than the limited information available on health care provider directories, which again often excludes information concerning the actual experience the doctors have with particular health conditions or ways to schedule an appointment with them in a timely fashion.

Such problems identifying experts are exacerbated in remote areas of the world, where the number of experts in a given field or experienced with a particular disease or condition may be few or located far away from the patient. Telemedicine, or the practice of providing health care remotely, asynchronously (store-and-forward method) or synchronously (real-time video), may be used to mitigate the problems associated with health care in such remote locations. However telemedicine service providers often do not share health care treatment information, which prevents them from developing a centralized knowledge base of experts in a particular condition or disease. Some current telemedicine systems are limited to particular disease categories and require large up-front infrastructure, technology development, and personnel investments. In addition, such siloed health care systems frustrate or limit the development of clinical trials or research programs, which often require such amounts of patient data on a particular condition or disease massive a that a single siloed health care provider's data would be insufficient by itself. And because no centralized database that aggregates ongoing diagnosis and treatment information across providers exists, these clinical trials or research programs tend not to consider treatment information from more than one provider, thereby failing to capture potentially important data from providers across diverse geographic regions that treat demographically diverse individuals.

Within the United States, the Health Insurance Portability and Accountability Act of 1996 (“HIPAA”) provides patients with stringent privacy and safety protections. One common criticism of modern telemedicine is that it has the potential to expose patient information in violation of HIPAA if the data is intercepted by a third party. Such interception can occur at any phase: the device that records the patient health information can be lost, stolen, or otherwise compromised; the information sent to the central telemedicine service provider, often received at or by a server, can be intercepted in transit; or the provider's server can be compromised. With so many possible points of failure, telemedicine raises significant cause for concern despite its many possible benefits.

### SUMMARY OF THE INVENTION

A main object of the present invention is to allow individuals having access to a device, such as a mobile device or computer, to obtain expert advice tailored to the individuals' needs from a variety of experts who all preferably need to contribute to developing an effective treatment plan, while allowing the individuals' information and communications to be secure and reliable.

Another object of the present invention is to expand the expert network accessible to individuals through referred expert's internal network of other esteemed experts who can contribute to determining an effective treatment plan.

Yet another object of the present invention is to provide enhanced information about each expert to individuals; in particular information about whether the expert has had direct experience with the individual's issue.

Still yet another object of the present invention is to provide expert advice in this manner and preferably to permit those who wish to conduct clinical trials, research programs or focus groups to access the comprehensive database so that they are not limited to the information made available by individual service providers.

A further object of the present invention is to provide a secure method of storing and transmitting sensitive user information, or in particular patient health information in medical applications, to protect end users such as patients, and to comply with the pertinent privacy laws and other norms.

These and other objects and advantages are achieved by the system and method according to the present invention. A provider establishes a wireless connection with a mobile device or computer of a user, wherein the user has been provided with an application on the mobile device or computer that allows the user to enter information about which to seek advice. The provider then receives the information from the mobile device or computer at the provider's server and decrypts the information, if necessary. After analyzing the information and determining what type of expert is needed, unless the type of expert was identified by the user in the received information, the provider forwards the received information to one or more experts of the selected type. Once the selected experts have evaluated the forwarded information and provided their recommendation in the form of a response, the provider receives the response or responses and aggregates contribution from various experts and assembles them into an effective treatment plan, then relays them to the user of the mobile device or computer. In the health care context, the user may be a patient, health care provider such as a doctor, nurse, health care worker, or a local person tasked with health care, or even friends or family members of the patient.

In a preferred embodiment, a user is asked to enter his or her credentials when establishing a wireless connection in the form of a username and password combination, facilitating data security and personalization. These credentials are then combined with a unique identification code assigned to the mobile device or computer to create a digital signature to be sent to the provider.

Once the user's credentials have been accepted and a connection established, the user enters responses to one or more queries into the application on the mobile device or computer. In a preferred embodiment, the mobile device or computer is connected wirelessly or by wire to a sensor, which can directly acquire additional information from the end user. Such a wireless connection can be implemented using standard wireless protocols such as Bluetooth, Wi-Fi, Near-Field Communications or “NFC,” or other radio communication. Examples of such sensors are cameras or other light sensors, motion sensors, microphones, and scales. In the health care context, the sensor or medical device can measure patient health information such as, but not limited to, heart rate, blood pressure, blood sugar levels, or sounds external or even internal to the patient.

In accordance with a preferred embodiment of the present invention, these responses and gathered data are encrypted on the mobile device or computer to secure them from being lost, stolen, or otherwise compromised, for example by “malware,” software put on the mobile device or computer designed to intercept private data or usurp control of the device. This has additional utility in the health care context because patient health information is often sensitive and private, and local encryption protects the data.

Also, in accordance with another preferred embodiment of the present invention, the provider receives the user's response information and any pertinent demographic information about the user. In a preferred embodiment, the transmitted response information is also encrypted to prevent interception. The provider decrypts the user response information, if it was encrypted, and then forwards some or all of the response information to some or all experts listed in a database of experts according to the expert type. For example, in the health care context, an expert type can be a specialty, such as, but not limited to, dermatology, urology, endocrinology, oncology, internal medicine, pulmonology, or ophthalmology; in the financial context, an expert type can be financial advisor, retirement advisor, or tax advisor; in the legal context, an expert type can be individuals well-versed in social security benefits for health care needs. The type of expert can be chosen by the user and sent as part of its response information, or alternatively by the provider after receiving the response information.

Once the expert type has been selected and the provider has the user information, the provider preferably forwards the user information to one or more experts of the selected type. The experts can themselves forward the user information to additional experts if they desire to confer with other experts before rendering advice on the user's issue. The experts can then preferably collaborate in real-time or non-real-time to form a consensus opinion on the issue presented. These experts preferably consult each other in real time via telephone conference, VoIP, video conference, in person, or by any other real-time electronic communication. They preferably also consult with each other in non-real time by exchanging messages via web-based applications or mobile-smartphone applications, recorded audio or video messages, electronic mail, regular mail, or any other electronic communication in a fashion compliant with privacy and security rules. In the health care context, this operates as an electronic grand round whereby the medical experts consult each other's experience and knowledge to determine the proper diagnosis or course of treatment.

After the experts provide a course of conduct or treatment regimen based on the information provided to them, the provider preferably receives additional information from the mobile device or computer of the user about the course of conduct or treatment that was actually taken. Based on such additional information, a follow-up consultation can preferably be initiated either by the expert or by the user to provide expert follow-up advice.

In accordance with a preferred embodiment of the present invention, the provider can assemble all of its users' demographic information and the users' responses to queries and store them in a database, to be made available for analysis in research programs to improve care delivery or treatments. By the use of this method, information limitations that might be otherwise imposed on entities or individuals seeking to implement large-scale studies do not apply. For example, in the health care context, large health care providers often do not share patient data or treatment data with other providers. This limitation often precludes clinicians from conducting studies with as many data samples as they might need to effectuate a more reliable or statistically significant conclusion or result.

Additionally, in the health care context, because patient privacy is so highly valued, the patient health information to be stored in such a database can be anonymized by removing, modifying, or replacing some or all personally identifiable information. This database of patient health information can be used to match patients with given medical histories, illnesses or conditions, or genetic or personal characteristics to relevant clinical trials or research programs. The anonymized patient health information is useful for practitioners who wish to conduct clinical trials or research programs, and can leverage the large amount of data and number of patients by using a database associated with the present invention. By doing so, those practitioners can eliminate the problems commonly associated with large health care providers' unwillingness to share patient or treatment information.

In a particularly preferred embodiment, the method according to the present invention is implemented by a system in accordance with the present invention comprising at least one secure mobile device or computer, a medical-expert-matching software module hosted by a web-based application server, a remote patient-management and consultation software module providing access to patient health data, a searchable multiple-media database composed of patient health data and diagnosis treatment plans. The secure mobile phone is wirelessly connected to the server. The remote patient-management and -consultation software module and the medical-expert-matching software module can be implemented by software or firmware, and alternatively by hardware alone or in combination with software or firmware.

The secure mobile device or computer according to this preferred embodiment comprises device-level security methods to provide secure web-based communications of patient health information to the health care provider from the mobile device or computer. These security methods can include: on-device encryption of patient health information using software, hardware or firmware, or some combination of the three, which provides security against unauthorized use of the mobile device or computer; destruction of patient health information after transmission of the patient health information to the provider; and user authentication over the Internet to ensure that access to the provider is authorized.

The medical-expert-matching software module according to this preferred embodiment enables exchange of patient health information to a medical expert and facilitates a dialogue among additional health care providers to develop a diagnosis and treatment plan for the patient. This module can optionally comprise a peer-inviting software module that enables a medical expert to invite peers to collaborate on a treatment plan for the patient. It may also optionally comprise a mobile, Internet-based grand-rounds session software module providing an Internet-based platform for live or non-real-time interactive sessions between health care professionals, which the health care professions use to discuss patient symptoms and contemplated courses of treatment or treatment protocols.

The remote patient-management and -consultation software module according to this preferred embodiment enables coordinated care between health care professionals from the same or separate locations.

The searchable multiple-media database according to this preferred embodiment can contain any or all of the following: patient health information; diagnoses corresponding to such patient health information; treatment plans corresponding to such patient health information; non-health metadata about patients such as location and demographic information; and at least one table in the database linking patients with other patients based on such patient health information. The searchable multiple-media database can also be used to manage chronic or widespread diseases, or to train health care professionals in optimal treatment plans based on information contained in the database.

These and other feature and advantages of the present invention will become apparent from the following detailed description of the invention with reference to the attached drawings, wherein:

### BRIEF DESCRIPTION OF THE DRAWINGS

FIG. 1 is a block diagram of one embodiment of a system for carrying out the method according to the present invention;

FIG. 2 is a block diagram of one embodiment of a mobile device or computer for use with the method and system of the present invention;

FIG. 3 is a block diagram of another embodiment of a system for carrying out the method according to the present invention;

FIG. 4 is a flow chart of one embodiment of the method according to the present invention;

FIG. 5 is a flow chart of a further embodiment of the method according to the present invention illustrated in FIG. 4;

FIG. 6 is a flow chart of another embodiment of the method according to the present invention;

FIG. 7 is a screen shot of a software application implementing one embodiment of the method according to the present invention;

FIG. 8 is another screen shot of a software application implementing one embodiment of the method according to the present invention; and

FIG. 9 is yet another screen shot of a software application implementing one embodiment of the method according to the present invention.

FIG. 10 is yet another further screen shot of a software application implementing one embodiment of the method according to the present invention.

### DETAILED DESCRIPTION OF THE INVENTION

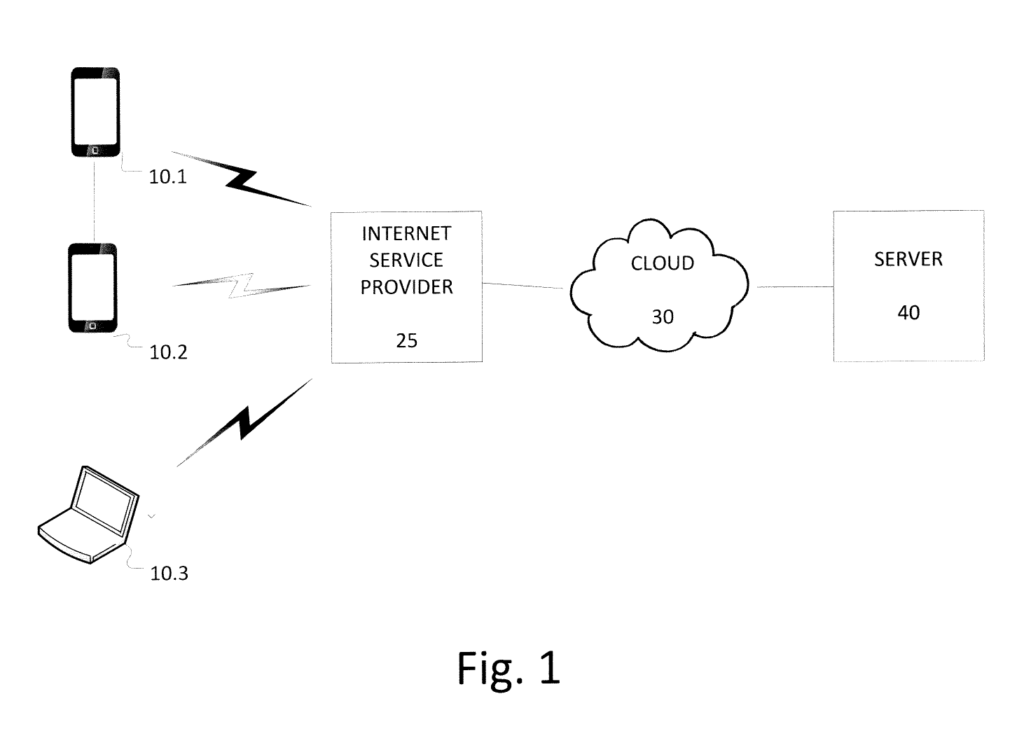

Referring now to FIG. 1, a system for carrying out the method of the present invention is shown. In that system, the server 40 is electronically connected to the cloud 30, where the cloud 30 can be a single computer, a network of computers, the Internet generally, or an entity that hosts application services on a networked system of computers such as Amazon Web Services, VMWare's cloud hosting services, or Apple's iCloud service. Examples of server 40 include one or more computers or computer systems running Windows Server 2012, Apple's OSX Server, or a version of Linux, such as AIX or HP-UX, or another server operating system such as VMS. The cloud 30 is connected to an Internet service provider (“ISP”) 25, which can be any one of the following types of entities providing Internet connectivity services: a cable operator, such as Comcast, Time Warner, or Cox Communications; a telecommunications carrier, such as Verizon, AT&T, or CenturyLink; a wireless telecommunications carrier, such as Verizon, AT&T, Sprint/Nextel, T-Mobile, Clearwire, or FreedomPop; or a dial-up ISP, such as NetZero or America Online.

The ISP 25 is then wirelessly connected to at least one mobile device or computer 10.1-10.3. The number of mobile devices or computers 10.1-10.3 connected to the ISP 25 may range from one to many, and are not limited to three. Examples of mobile devices 10.1-10.2 include smartphones such as the iPhone 4, 4s, 5, 5s or 5c running a version of Apple's iOS operating system; the Google Nexus series, Samsung Galaxy series, Motorola Droid series, Sony Xperia series, or the various iterations running Google's Android operating system; the LG Optimus or Quantum smartphones, the Nokia Lumia series of smartphones, the Samsung Focus or Omnia series of smartphones, or the various iterations manufactured running Microsoft's Windows Phone 7 or 8 operating system; and the BlackBerry Z30, Q10, Q5, Z10, Bold, Torch, Curve, or Pearl series of smartphones running BlackBerry's BlackBerry 10 mobile operating system. Other examples of mobile devices 10.1-10.2 are tablet computers, such as Apple's iPad or iPad mini, Google's Nexus 7 or 10, Motorola's Xoom, or Samsung's Galaxy Tab. Mobile devices 10.1-10.2 may also be wearable devices such as Google Glass, Pebble watches, or a wearable device made by FitBit such as the FitBit Force, Flex or Zip. Examples of computers 10.3 include desktop, laptop or netbook computers running operating systems such as Microsoft Windows 98, 2000, ME, XP, 7, or 8, or Enterprise varieties thereof; BSD- or GNU-based Linux distributions such as Red Hat, SUSE Linux, Debian, Google Chrome OS, Fedora, or Ubuntu; and Apple Inc.'s OSX or OSX Server operating systems. The wireless connection between the mobile device or computers 10.1-10.3 and the ISP 25 can be implemented using, for example, a cellular network such as LTE, CDMA or GSM; Wi-Fi such as the 802.11a, 802.11b, 802.11g, 802.11n, or 802.11ac standards; Bluetooth; NFC; RFID; or infrared.

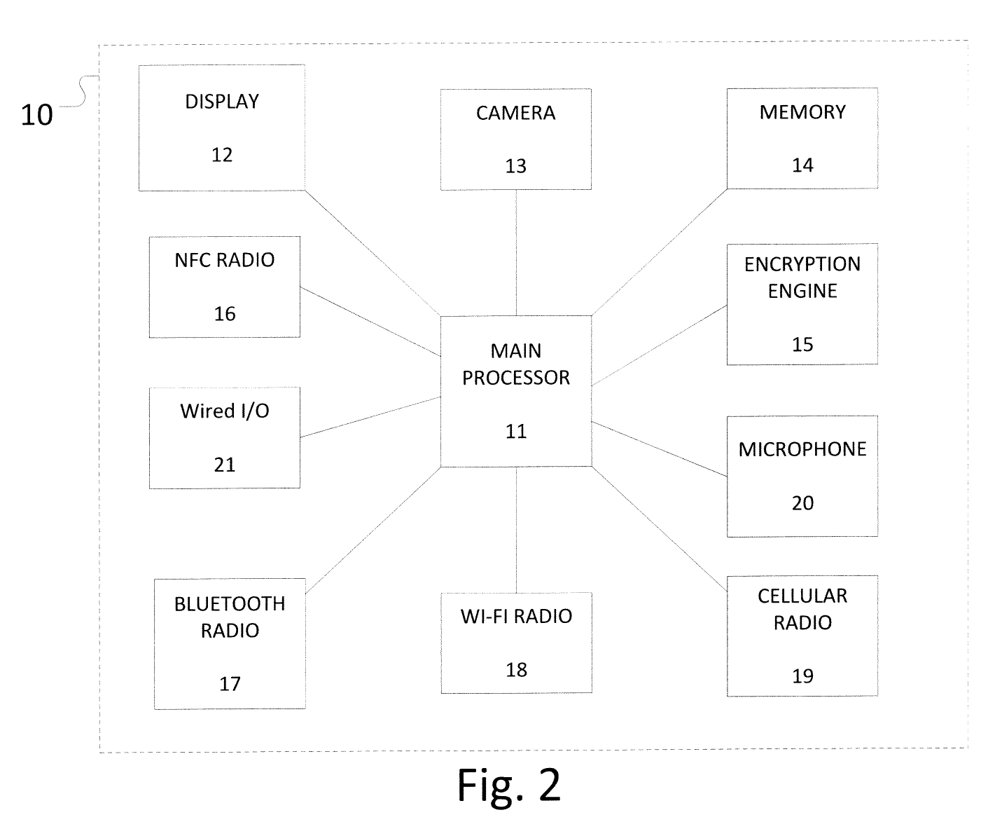

FIG. 2 illustrates a preferred configuration of a mobile device or computer 10 for use with the present invention. The main processor 11 can be any mobile central processing unit, such as Qualcomm's Snapdragon family of processor systems, Nvidia's Tegra family of processors, Apple's Ax chipset line, Intel's Atom, Texas Instruments' OMAP chipset series, Samsung's Exynos processors, ST-Ericsson's NovaThor chipsets, or the i.MX processors by Freescale Semiconductor, the RK3xxx processor family by Rockchip, the A31 by AllWinner, the MTxxxx line by MediaTek, or Broadcom's BCM2xxxx family of microprocessors; or any CPU based on the x86 or Power architectures. The main processor 11 is electronically connected to any or all of the following: a display 12, a camera 13, volatile or non-volatile memory 14, an encryption engine 15, a microphone 20, a cellular radio 19 such as LTE, a Wi-Fi radio 18 using the 802.11n or 802.11ac wireless standards, a Bluetooth radio 17, at least one form of wired input/output connection (“I/O”) 21, and a Near-Field Communications (“NFC”) radio 16.

The display 12 can be a touchscreen display, for example a resistive touchscreen, a capacitive touchscreen, a touchscreen using surface acoustic wave technology, using an infrared grid, or acoustic pulse recognition. But the display 12 need not also be a means of obtaining user input; the mobile device or computer 10 can acquire user input by analog means such as a keyboard, keypad, trackpad, mouse, by non-keyboard tactile input such as tapping, or by an optical device observing user gestures such as Microsoft's Kinect technology or Google Glass's blink recognition.

The camera 13 can be any optical device capable of capturing images and storing them on the mobile device or computer. Such images may be still photographs or videos, with sound for said videos being recorded by the microphone 20.

The encryption engine 15 can be alternatively implemented by hardware or software. In a hardware embodiment, encryption is performed by a dedicated piece of hardware such as a secure cryptoprocessor or other cryptographic processor. In a software embodiment, encryption is carried out by a software program running on the mobile device or computer 10 that uses an encryption algorithm such as the Advanced Encryption Standard (“AES”), RC6, Serpent, MARS, or Twofish.

The wired input/output connection (“I/O”) 21 can be any wired connection that allows data throughput. Examples are USB, micro USB, mini USB, HDMI, Mobile High-definition Link (“MHL”), S-Video, VGA, DVI, Apple's proprietary Lightning, Thunderbolt, or 30-pin connectors, an SD card, micro SD card, or pico-SD card.

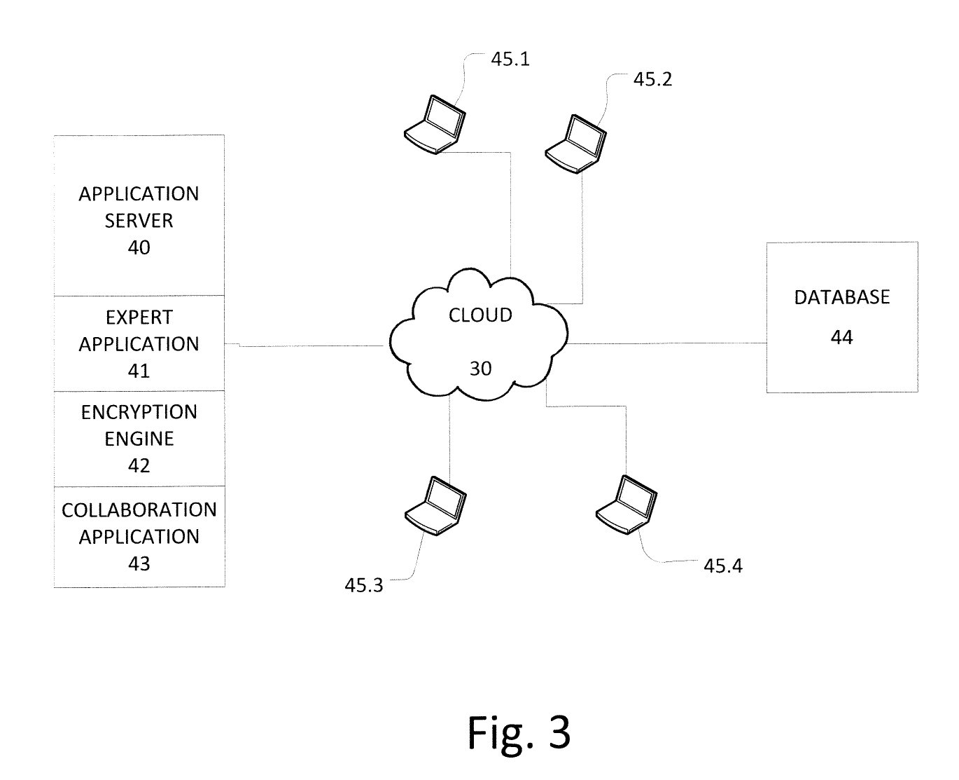

FIG. 3 illustrates one embodiment of a system in accordance with the present invention. An application server 40 hosts an expert application 41 such as a medical-expert-matching software module optionally comprising a peer-inviting software module and also optionally comprising a mobile, Internet-based grand-rounds session software module; an encryption engine application 42; and a collaboration application 43, such as a remote patient-management and -consultation software module, are used on either one system or on multiple systems at the same location. The expert application 41, encryption engine application 42, and collaboration application 43 can also be subroutines of the application server 40 or can be standalone applications. The system or multiple systems are electronically connected to the cloud 30 by a network such as the Internet. Experts 45.1-45.n and a database 44 are electronically connected to the application server 40 and expert application 41 through the cloud 30 by way of a network such as the Internet. The encryption engine 42 can alternatively be implemented by hardware or software.

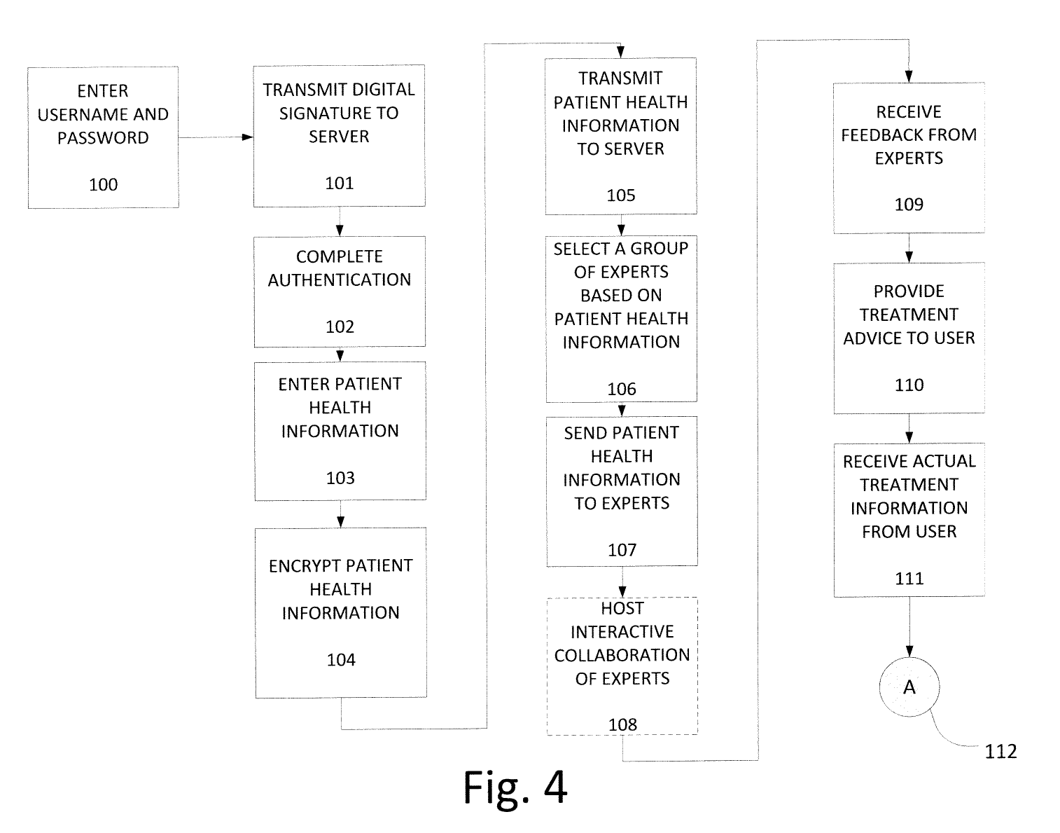

FIG. 4 shows a flow chart in accordance with one embodiment of the method of the present invention in the health care context. In step 100, the user enters his or her username and password on a mobile device or computer 10, which is combined with a device-identification code unique to the mobile device or computer 10 into a digital signature. The user may be a patient or health care provider. The combined digital signature is then electronically transmitted to the application server 40 in step 101. The application server verifies the digital signature of the user in the authentication step 102. All communications in accordance with the present invention may be optionally encrypted at the source and decrypted at the destination in order to enhance security.

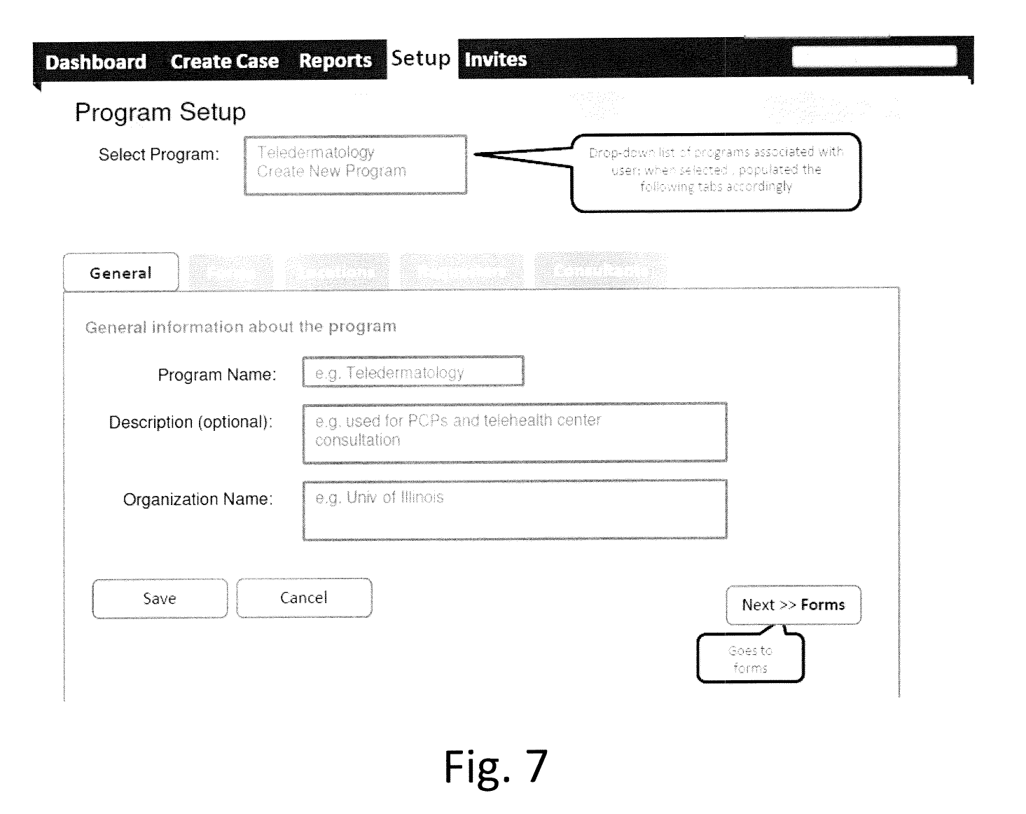

If the digital signature of the user is authenticated by the server, in step 103 the user is prompted on the mobile device or computer 10 to enter the patient health information, which can consist of at least the patient's personal information such as name, address, age, weight, and height; the patient's demographic information such as race and gender; the patient's health information such as known allergies, past and present health conditions, past surgeries and other medical information. A preferred embodiment of the user interface for the entry of patient health information is depicted by the screen shots in FIGS. 7, 8 and 10.

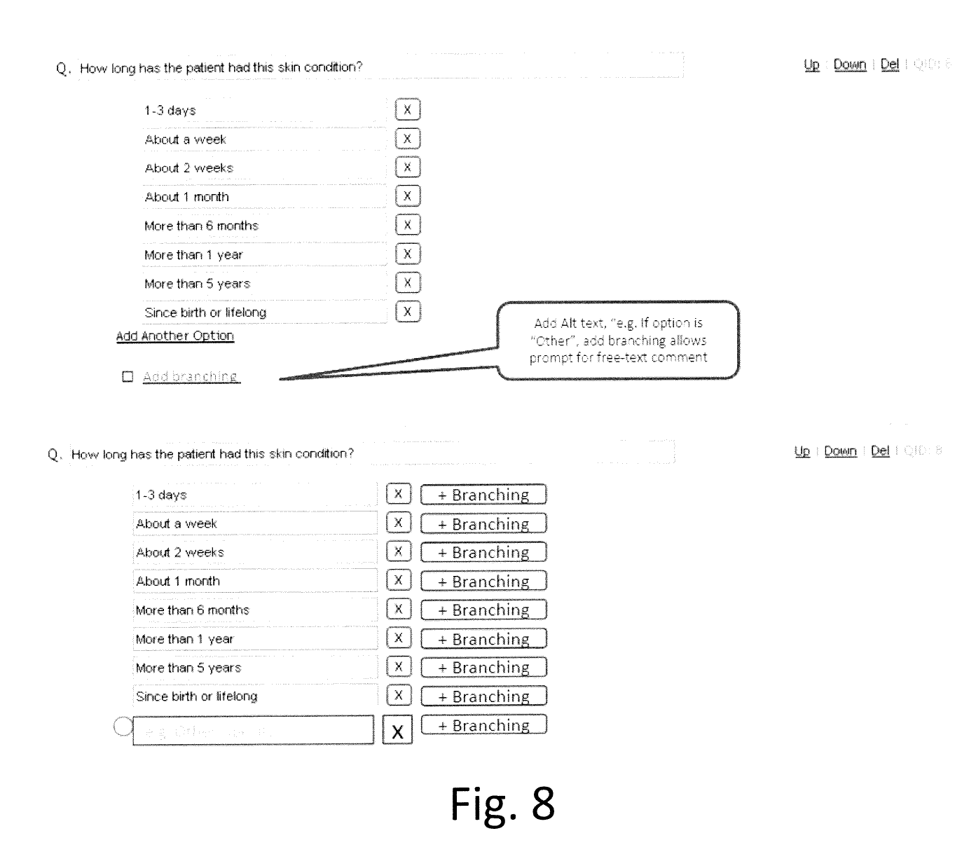

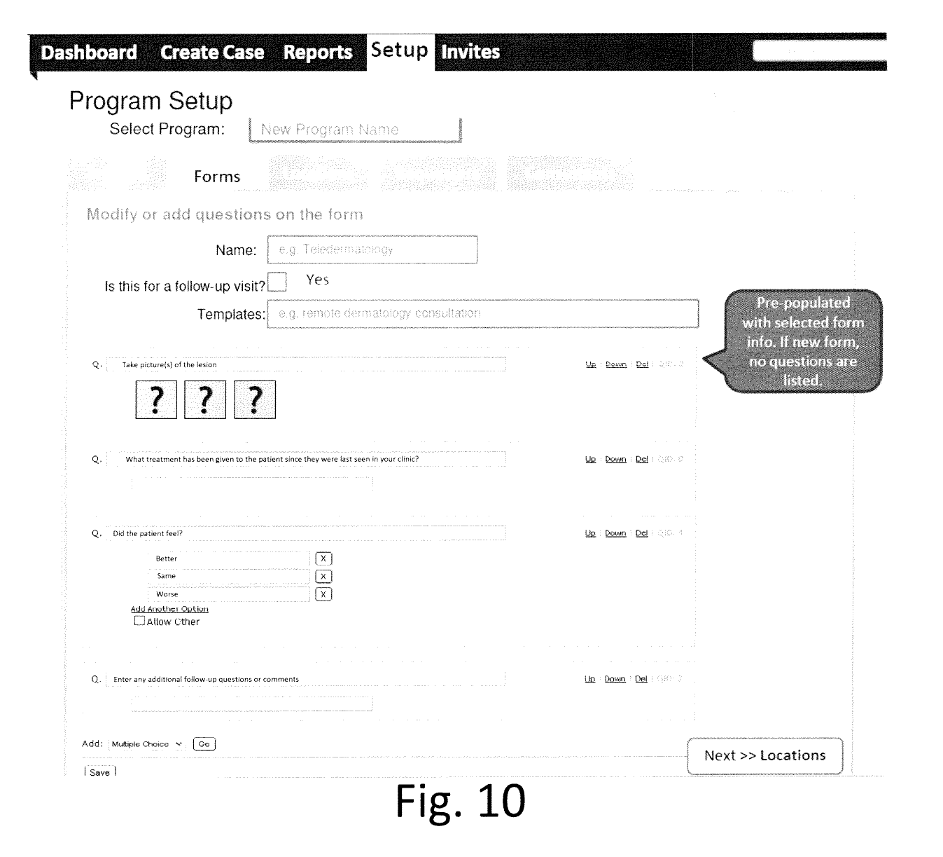

FIG. 7 shows a preferred embodiment of a form for the entry of patient health information, wherein the information provided by a user includes the user's organizational affiliation. FIG. 8 shows a preferred embodiment of a form for the entry of patient health information, wherein the information provided by a user includes a response to a query about the patient's health condition and wherein the form is capable of expanding to allow the user to enter a free-form response. FIG. 10 shows a preferred embodiment of a form for the entry of queries to be asked of a patient and predetermined responses to those queries, multiple-media information to be appended to patient health information, and any other relevant information.

The patient health information can also contain information about the patient directly obtained by any medical devices connected to the mobile device or computer 10 that transmits information to the mobile device or computer 10 by one of the interfaces shown in FIG. 2 such as the microphone 20, cellular radio 19, Wi-Fi radio 18, Bluetooth radio 17, NFC radio 16, or wired I/O connection 21. Such medical devices can meet, but are not limited to, the definition maintained by the United States Food and Drug Administration, including medical machines, contrivances, implants, in vitro reagents, or other such devices for the use of treating or diagnosing conditions in humans or animals. The user also enters any other relevant patient health information, optionally including the type of medical expert needed to evaluate the patient's illness, ailment or condition, into the application running on the mobile device or computer 10. Examples of the type of medical expert include any medical specialty, for example allergy and immunology, anesthesiology, cardiology, dermatology, dietetics, emergency medicine, endocrinology, family medicine, gastroenterology, geriatrics, gynecology, hepatology, infectious disease, intensive care, nephrology, neurology, neurosurgery, obstetrics and gynecology, oncology, ophthalmology, oral surgery, otorhinolaryngology, palliative care, pathology, pediatrics, physiatry, plastic surgery, podiatry, proctology, psychiatry, pulmonology, radiology, rheumatology, stomatology, urology, or any related surgical specialty.

Next, in step 104 the mobile device or computer 10 uses the encryption engine 15 to locally encrypt the patient health information provided by the user. The encrypted patient health information is then securely transmitted via the Internet service provider 25 shown in FIG. 1 and through the cloud 30 to the application server 40 in step 105.

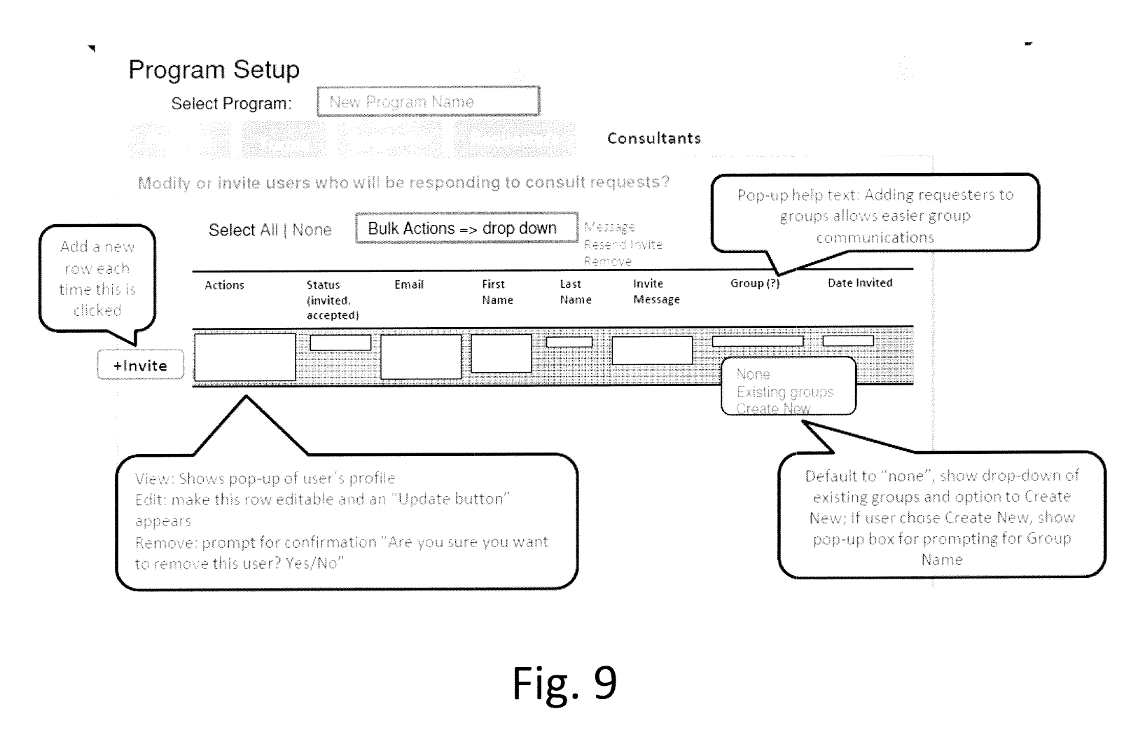

Once the application server 40 has received and decrypted the patient health information using the application server's decryption engine 42, in step 106 the application server 40 transmits the patient health information to the expert application 41, which selects the type of medical expert either on the basis of the type requested by the user in step 105 or on the basis of the patient health information received by the application server 40. The expert application 41 then sends the patient health information to the selected experts in step 107, by way of a hosted remote patient-management and -consultation software module that allows at least one medical expert 45.1-45.4 to view and comment on patient health information by connecting to the application server 40, expert application 41, or collaboration application 43 by way of the cloud 30. The number of medical experts 45.1-45.4 may range from one to many, and are not limited to four. The screen shot in FIG. 9 depicts a preferred embodiment of a user interface of the hosted remote patient-management and -consultation software module that provides for the forwarding of patient health information to medical experts.

After examining the patient health information, the at least one medical expert 45.1-45.4 may optionally host an interactive collaboration of medical experts in accordance with step 108 by using the collaboration application 43, whereby at least one other expert examines and analyzes the patient health information and communicates her opinion regarding diagnostic or treatment information to at least the medical experts 45.1-45.4. This communication may be real-time, for example in the form of a video- or audio-conference via the Internet, Voice over Internet Protocol (“VoIP”) or traditional telephone; or it may be non-real time, for example in the form of an electronic textual message, a voice message, an electronic textual message or voice message accompanied by multimedia data such as one or more pictures or videos.

After the at least one medical expert 45.1-45.4 and any other experts collaborated with in step 108 have rendered an opinion regarding for example a course of treatment or diagnosis, the expert application 41 receives the opinion from the experts in step 109. In step 110, the application server 40 then provides to the user the diagnostic or treatment information acquired from the at least one medical expert 45.1-45.4 in step 109 and optionally step 108. Finally, in step 111, the application server 40 receives from the user the course of treatment actually provided to the patient based on the recommendation of the at least one medical expert 45.1-45.4. In a particularly preferred embodiment, the medical expert recommendations, the treatment information, the patient health information, and information about which medical experts provided which recommendations will be securely stored in a database 44 connected to the application server 40 by way of the cloud 30 and available for future use.

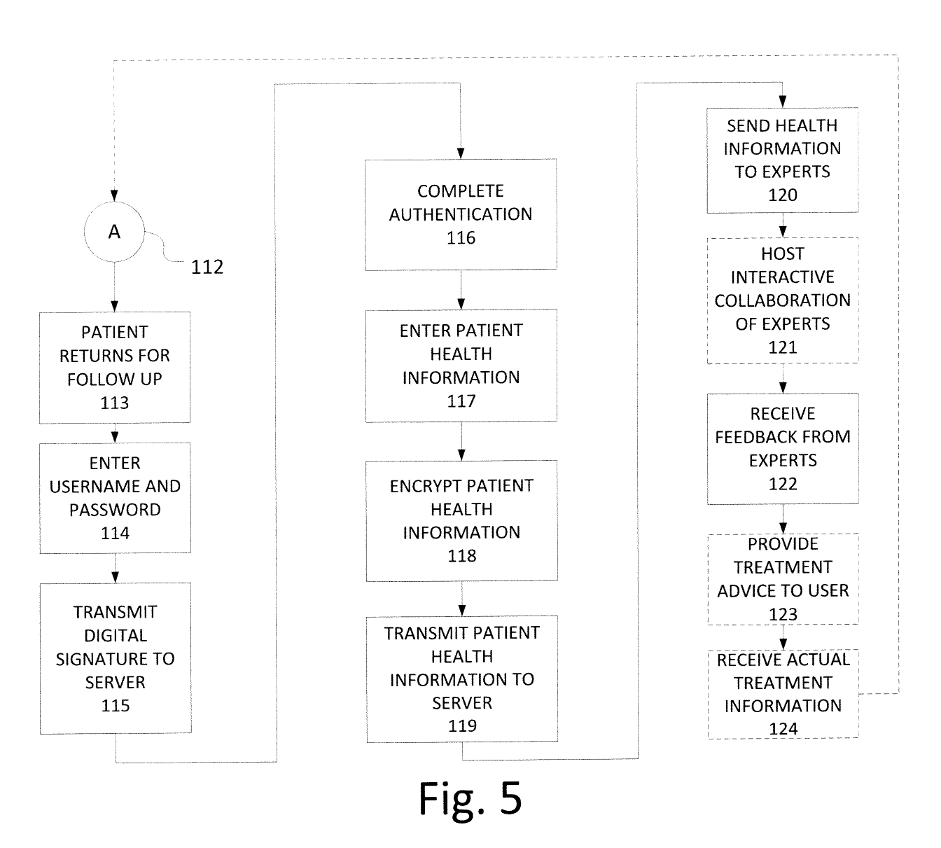

The flow chart according to the present invention shown in FIG. 4 can optionally be followed by the flow chart shown in FIG. 5 at step 112. Based on the treatment advice provided in step 110 and the actual treatment provided and reported in step 111, according to the flow chart in FIG. 5 the patient returns for a follow-up examination 113 so that the health care provider and one or more medical experts may evaluate the effectiveness of the provided treatment. At the follow-up examination, in step 114 the user again enters her username and password on a mobile device or computer 10, which is combined with a device-identification code unique to the mobile device or computer 10 into a digital signature. The user can again be a patient or health care provider. The combined digital signature is again electronically transmitted to the application server 40 in step 115. The application server verifies the digital signature of the user in the authentication step 116.

If the digital signature of the user is authenticated by the server, in step 117 the user is prompted on the mobile device or computer 10 to enter any new patient health information that was not already transmitted in the flow chart shown in FIG. 4 in steps 105 or 111. Such information includes, for example, the patient's health or change in condition after the treatment advice provided in step 110 or new medical information obtained from a medical device connected to the mobile device or computer 10.

Next, in step 118 the mobile device or computer 10 again uses the encryption engine 15 to encrypt the patient health information provided by the user locally. The encrypted patient health information is then securely transmitted via the Internet service provider 25 shown in FIG. 1 and through the cloud 30 to the application server 40 in step 119.

Once the application server 40 has received and decrypted the patient health information using the application server's encryption engine 42, in step 120 the expert application 41 then sends the patient health information to the same medical experts selected in step 106, or alternatively new experts selected on the basis of the patient health information, by way of the hosted remote patient-management and -consultation software module.

After examining the patient health information, in optional step 121 the medical experts 45.1-45.n can again host an interactive collaboration of medical by using the collaboration application 43, whereby at least one other expert examines and analyzes the patient health information and in real-time or non-real-time communicates her opinion regarding diagnostic or treatment information to at least the medical experts 45.1-45.n.

After the at least one medical expert 45.1-45.4 and any other experts collaborated with in step 121 have rendered an opinion, the expert application 41 receives said opinion from the experts in step 122. If no further treatment is deemed necessary by a consensus of the at least one medical expert 45.1-45.4 and any other experts collaborated with in step 121, the method according to the present invention can end. But alternatively, if further treatment is deemed necessary, in optional step 123, the application server 40 provides to the user the diagnostic or treatment information acquired from the at least one medical expert 45.1-45.4 in step 122 and optionally step 121. In step 124, the application server 40 can optionally receive from the user the course of treatment actually provided to the patient based on the recommendation of the one or more medical experts 45.1-45.n if another follow-up evaluation is needed, in which case the method according to the present invention can continue beginning again at step 112. In a particularly preferred embodiment of the present invention, the medical expert recommendations, the treatment information, the patient health information, and information about which medical experts provided which recommendations will again be securely stored in a database 44 connected to the cloud 30 and available for future use by the application server 40.

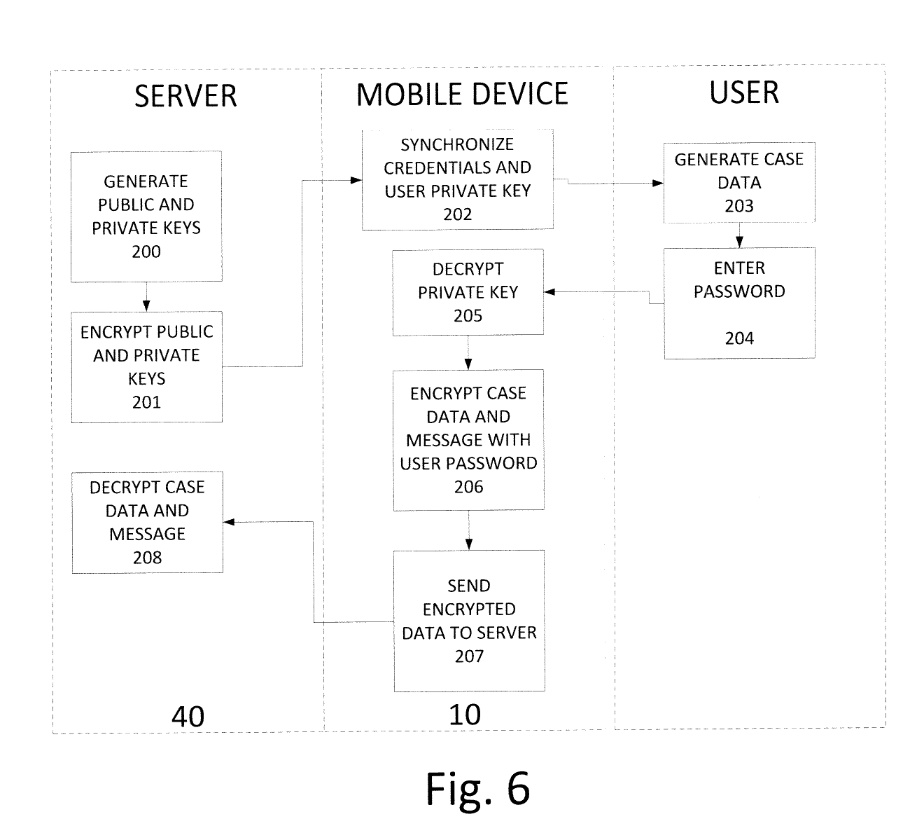

The flowchart shown in FIG. 6 illustrates a preferred embodiment of the process of securely storing and transferring user information from the mobile device or computer 10 to the application server 40 in accordance with the method of the present invention and performed in at least steps 103, 104, and 105. In step 200, the application server 40 uses the encryption engine 42 to generate public and private keys for use in encrypting data in accordance with known examples of public-key cryptography such as RSA or DSA. The public and private keys are encrypted a second time in step 201 by the encryption engine 42 using a different method of public-key cryptography such as AES. The mobile device or computer 10 then synchronizes the user's login credentials and the user's private key with the application server 40 in step 202, which may occur as a part of step 102 of the flowchart shown in FIG. 4. The user then inputs case data in the form of user information or patient health information 203, and enters its password 204 to encrypt the information, both of which may occur as a part of step 103 of the flowchart shown in FIG. 4.

The mobile device or computer 10 next uses its encryption engine 15 in step 205 to decrypt the private key created in step 200 by the application server 40, so that the mobile device or computer 10 can in step 206 encrypt the case data obtained in step 203 and any appended messages using the private key and the user's password obtained in step 204. The mobile device or computer 10 then in step 207 sends the encrypted data created in step 206 to the application server 40, which then uses its encryption engine 42 to decrypt the case data and appended message 208. Step 207 may occur as a part of step 105 in FIG. 4. An appropriate modification of the flowchart shown in FIG. 6 may also be applied to any other communication between or among the experts 45.1-45.n, the application server 40, and the user.

It is understood that the embodiments described above are merely illustrative and are not intended to limit the scope of the invention. It is realized that various changes, alterations, rearrangements and modifications can be made by those skilled in the art without substantially departing from the spirit and scope of the present invention.

What is claimed is:

1. A method for providing expert medical services comprising the steps of:
a. establishing a wireless connection with one of a mobile device and computer of a user, wherein the mobile device or computer has been provided with an application for the entry of patient health information;
b. receiving encrypted patient health information from the mobile device or computer at a server;
c. decrypting the patient health information at the server;
d. forwarding the patient health information from the server to one or more medical experts corresponding to the patient health information, said forwarded patient health information optionally being encrypted;
e. collecting responses at the server from said one or more medical experts; and
f. providing treatment advice to the user of the mobile device or computer.

2. The method according to claim 1, wherein the step of establishing a wireless connection comprises receiving a digital signature from the mobile device or computer at the server corresponding to a user name and password entered on the mobile device or computer and a device-identification code for the mobile device or computer.

3. The method according to claim 1, wherein the step of forwarding the patient health information from the server to one or more medical experts comprises the user first selecting the medical expertise of said one or more medical experts on the basis of the patient health information.

4. The method according to claim 3, comprising said one or more medical experts forwarding the patient health information to at least one additional medical expert selected by said one or more medical experts.

5. The method according to claim 1, wherein the step of forwarding the patient health information from the server to one or more medical experts comprises an application at the server first selecting on the basis of the patient health information at least one medical specialty of said one or more medical experts.

6. The method according to claim 5, comprising said one or more medical experts forwarding the patient health information to at least one additional medical expert selected by said one or more medical experts.

7. The method according to claim 1, wherein the patient health information is encrypted while stored in the mobile device or computer.

8. The method according to claim 1, wherein the step of collecting responses comprises an interactive collaboration of the medical experts using an application stored at the server.

9. The method according to claim 8, wherein the interactive collaboration of the medical experts occurs in real time.

10. The method according to claim 8, wherein the interactive collaboration of the medical experts does not occur in real time.

11. The method according to claim 1, further comprising receiving from the mobile device or computer actual treatment information following the provision of treatment advice.

12. The method according to claim 11, further comprising providing a follow-up consultation.

13. The method according to claim 12, wherein the follow-up consultation is initiated by the user.

14. The method according to claim 12, wherein the follow-up consultation is initiated by at least one of the medical experts.

15. The method according to claim 1, further comprising adding anonymized patient health information to an encrypted database, wherein said database comprises anonymized patient health information of at least one patient.

16. The method according to claim 1, wherein the user is a patient.

17. The method according to claim 1, wherein the user is a health care provider.

18. The method according to claim 1, wherein the step of providing an application for the entry of patient health information comprises information having been transmitted from a sensor interacting with a patient to the mobile device or computer.

19. The method according to claim 18, wherein the step of providing an application for the entry of patient health information further comprises selecting medical experts based on the information transmitted from the sensor.

20. The method according to claim 18, wherein the sensor has transmitted patient information to the mobile device or computer by Bluetooth.

21. The method according to claim 18, wherein the sensor has transmitted patient information to the mobile device or computer by Wi-Fi.

22. The method according to claim 18, wherein the sensor has transmitted patient information to the mobile device or computer by NFC.

23. The method according to claim 18, wherein the sensor measured heart rate.

24. The method according to claim 18, wherein the sensor measured blood pressure.

25. The method according to claim 18, wherein the sensor measured blood sugar levels.

26. The method according to claim 18, wherein the sensor measured sound waves.

27. The method according to claim 1, wherein the step of receiving encrypted patient health information at the server comprises the mobile device or computer having been used to photograph a medical condition of a patient.

28. The method according to claim 1, further comprising using the patient health information on the server to match patients to related clinical trials or research programs.

29. A method for providing expert services comprising the steps of:
a. establishing a wireless connection with one of a mobile device and computer of a user;
b. providing an application on the mobile device or computer for the entry of user information;
c. receiving encrypted user information from the mobile device or computer at the server;
d. decrypting the user information at the server;
e. forwarding the user information from the server to experts selected on the basis of the user information;
f. collecting responses from the experts;
g. providing advice to the user of the mobile device or computer.

30. The method according to claim 29, wherein the step of establishing a wireless connection comprises a user entering a user name and password on the mobile device or computer and transmitting a digital signature from the mobile device or computer to the server comprising the user name, password and a device identification code for the mobile device or computer.

31. The method according to claim 29, wherein the user information is encrypted while stored in the mobile device or computer.

32. The method according to claim 29, wherein the step of forwarding the user information from the server to experts comprises forwarding encrypted said user information to said medical experts.

33. The method according to claim 29, wherein the step of forwarding the user information comprises at least one of the experts forwarding the user information to at least one additional expert selected by said at least one of the experts.

34. The method according to claim 29, wherein the step of collecting responses comprises an interactive collaboration of the experts.

35. The method according to claim 29, further comprising using the mobile device or computer to transmit the results of the advice following the providing of said advice.

36. The method according to claim 29, further comprising providing a follow-up consultation.

37. The method according to claim 36, wherein the follow-up consultation is initiated by the user.

38. The method according to claim 36, wherein the follow-up consultation is initiated by at least one of the experts.

39. The method according to claim 29, wherein the step of entering user information comprises transmitting information from a sensor on a user to the mobile device or computer.

40. The method according to claim 29, wherein the step of entering user information comprises using the mobile device or computer to photograph the user.

41. The method according to claim 29, further comprising using the user information on the server to match users to related other users.

42. The method according to claim 29, wherein the step of providing an application on the mobile device or computer for the entry of user information is performed before the step of establishing a wireless connection with a mobile device or computer of a user.

43. A system for providing expert medical services, the system comprising:
a. at least one server, said at least one server comprising:
expert application software for forwarding patient health information to at least one medical expert;
encryption engine software for encrypting and decrypting patient health information received from one of a mobile device and computer; and
collaboration application software for facilitating an interactive collaboration of medical experts;
b. at least one database capable of securely storing patient health information; and
c. wherein the at least one server receives encrypted patient health information from a mobile device or computer and forwards encrypted patient health information to at least one medical expert to provide course-of-treatment information to the mobile device or computer.
